(19) United States
(12) Patent Application Publication
(10) Pub. No.: US 2002/0025050 A1
(43) Pub. Date: Feb. 28, 2002

(54) Spa audio system operable with a remote control

(76) Inventor: Stephen S. Macey, Oceanside, CA (US)

Correspondence Address: Price and Gess, Suite 250, 2100 S.E. Main Street, Irvine, CA, 92614-6238, US

(21) Appl. No.: 09/865,127

(22) Filed: May 24, 2001

Related U.S. Application Data
(63) Continuation-in-part of application No. 09/516,132, filed on Mar. 1, 2000.

(51) Int. Cl. H04R 1/02; H04R 9/06; A61H 33/02

(52) U.S. Cl. 381/87; 381/333; 381/334; 381/388; 4/546

(57) ABSTRACT

A portable spa including an audio system designed to use the spa shell as the sound generating device. Transducer devices are mounted within an enclosure which is bonded to the spa shell so as couple the sound vibration energy to the shell so that sound can be heard when using the spa.

### CROSS REFERENCE TO RELATED APPLICATIONS

This is a Continuation-in Part of Application Ser. No. 09/516,132, Entitled SPA AUDIO SYSTEM, filed Mar. 1, 2000, now abandoned; and, is related to co-pending Application Ser. No. ______, entitled TWO-WAY REMOTE CONTROL, filed on the same day hereof, by the same inventor hereof and assigned to the same Assignee hereof.

### BACKGROUND OF THE INVENTION

1. Field of the Invention

The subject invention relates generally to spas and more particularly to an audio system utilizing a spa shell as a sound-generating device and having a remote control therefor.

2. Description of Related Art

Existing spa audio systems use traditional speakers wherein the audio drivers are exposed to the harsh spa environment or require protection or esoteric materials to prevent premature failure. Existing spa audio systems also suffer from the limited space available to mount speakers. The resultant smaller speakers are incapable of reproducing full range audio (50Hz-17kHz).

Remote controls for electronic apparatus are not new. However, such prior art remote control devices use infrared light or sound for communicating with the controlled apparatus. These prior devices are quite satisfactory when used in the same room as the apparatus being controlled.

Therefore, a need exist for a remote control that can be used at locations without line of sight communication with the apparatus being controlled.

### SUMMARY OF THE INVENTION

An object of the present invention is to provide a remote control for a spa audio system that can receive a return signal indicative of the status of a given function of the system.

Another object of the present invention is to provide feedback from the spa audio system that indicates such things as power-on, status of the audio system, audio media selected, volume setting, etc.

Still another object of the present invention is to provide a spa audio system that employs an existing home entertainment system without the necessity of additional or special wiring.

Yet another object of this invention is to provide a remote control that is simple to use by employing only 3-button controls-1 button for mode selection and 2 buttons for ON or OFF/increase or decrease of the selected mode.

According to an aspect of the invention, a spa shell is employed as an audio driver with audio transducers mounted inside the skirt of the spa. The inventor has found that the spa shell provides both sufficient rigidity for high frequency reproduction and a sufficiently large surface area to achieve low frequency reproduction.

These and other objects, which will become apparent as the invention is described in detail below, are provided by an audio system for a spa having a flexible shell for holding water and a main control for controlling functions of the spa. The spa audio system includes a first transceiver coupled to a home stereo system and a second transceiver coupled to the main control. An amplifier is coupled to the main control and has outputs coupled to audio transducers. The audio transducers are attached to an outer portion of the spa shell for coupling sound vibration energy to the spa shell.

Still other objects, features and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

The general purpose of this invention, as well as a preferred mode of use, its objects and advantages will best be understood by reference to the following detailed description of an illustrative embodiment with reference to the accompanying drawings in which like reference numerals designate like parts throughout the figures thereof, and wherein:

FIG. 1 illustrates the remote control for use with a spa audio system in accordance with a specific embodiment of the present invention;

FIG. 2 is a more detailed diagram of the display of the remote control;

FIGS. 3A - 3F illustrate a variety of data displays for the remote control shown in FIGS. 1 and 2;

FIG. 4 illustrates an enclosure apparatus for attaching transducers to the spa shell;

FIG. 5 is a cross-sectional diagram of the transducer used in the present invention; and

FIG. 6 is a block diagram of the electronic structure of the remote control.

### DETAILED DESCRIPTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved spa audio system and a RF remote control apparatus for controlling the same.

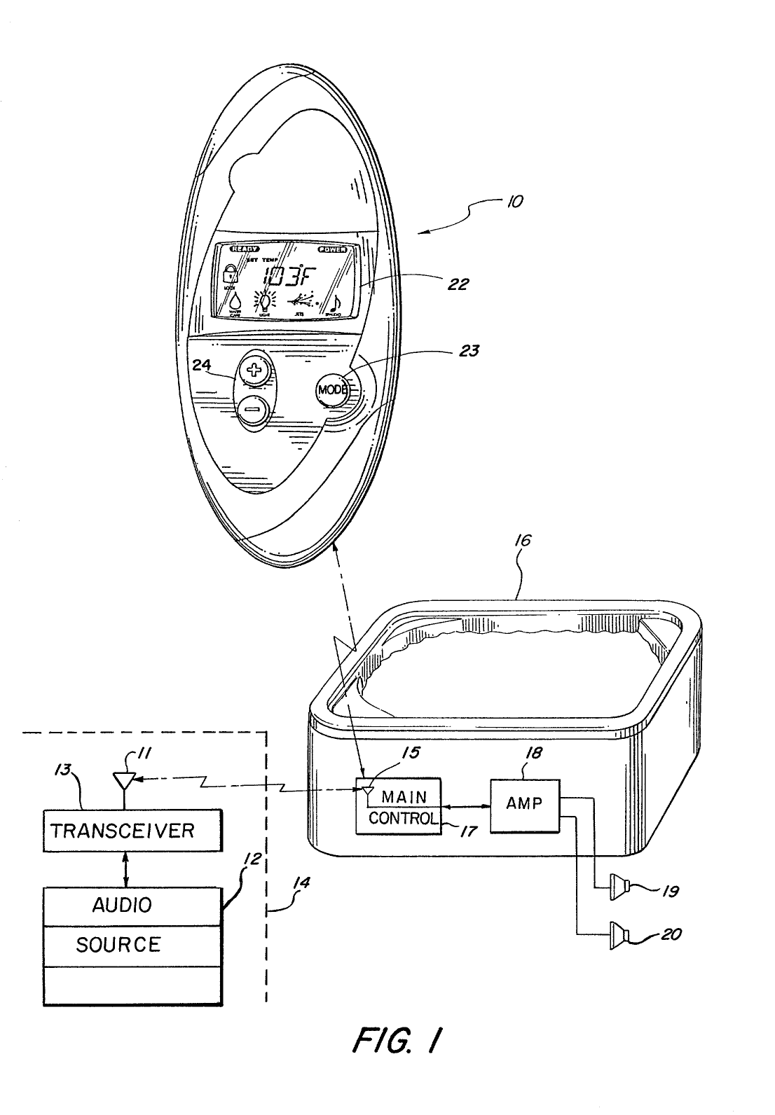

Referring now to the drawings and FIG. 1 in particular, a remote control 10 is illustrated in use with a spa audio system in accordance with a specific embodiment of the present invention. RF signals from the remote control 10 are low power, but adequate to reach an antenna 15 coupled to a main control 17 within or near a spa 16. The main control then communicates with an audio source 12 through an antenna 11 and a transceiver 13 within a house or structure 14. The antenna 11 is capable of transmitting media material (e.g., music) back to the antenna 15 within the spa 16. The music carrying signal picked up by the antenna 15 is processed by the main control signal 17 and amplified by an amplifier 18, where it is then supplied to speakers 19, 20 affixed to the shell of the spa 16 as will be explained hereinafter. The amplifier 18 may be a conventional integrated power amplifier, providing e.g., 100-300 watts of power per channel. The remote control 10 and the main control 17 are described in greater detail in U.S. patent application Ser. No.______, entitled TWO-WAY RF REMOTE CONTROL filed on______, 2001.

The signal power transmitted by the antenna 11 is preferably low so to avoid interference with a neighbor's radio or television reception, but strong enough to reach the spa outside of the structure 14. The remote also receives status signals back from the home stereo 12 regarding the status of such things as the media selected, volume, and the like; which will be explained further hereinafter. The remote control 10 includes a display 22 having icons displayed thereon, which represent various functions to be described hereinafter. The remote control 10 also includes a mode button 23 for changing the function of the remote from one mode to another; and, a +/− (“ON/OFF” or “increase/decrease”) button 24 for use in conjunction with the mode button 23 for changing or setting a function. The remote control 10 is powered by three AAA batteries, is waterproof and may be used by while bathing in the spa 16.

Referring now to FIG. 2, the display 22 of the remote control 10 is shown in greater detail. The display 22 includes numerous icons, which indicate the status of various functions of the spa 16. A Ready icon 26 will illuminate when the temperature of the water in the spa 16 is within 2 degrees of the selected temperature. A Power icon 27 will illuminate when the spa system is turned on and power is connected. An Alpha/Numeric display array 28 is disposed for indicating numerous functions selected by the mode switch 23, or for displaying information received back from the main control 15. For example, when the temperature is selected, a Temp icon 30 illuminates and the temperature of the water is indicated by the display array 28. When a temperature setting is to be selected, a Set icon 31 will illuminate and as the +/− switch 24 is moved (up or down) the temperature to be selected will be shown by the display array 28. As the remote control 10 communicates with the transceiver 13 a Comm icon 32 will flash, which indicates communication is taking place between the two units.

Additional functions indicated by the display 22 include a Water Care icon 33, which when illuminated indicates that the sanitary system of the spa 16 is operating normally. A Light icon 34 will illuminate when the mode switch 23 is stepped to the spa light switch. Depressing the + side of the switch 24 will turn the spa light on and depressing the − side of the same switch 24 will turn the spa light off. In a similar fashion, the jets of the spa can be turned on and off, and when the mode switch is in the jets mode a Jets icon 35 illuminates. A SpAudio icon 36 illuminates when the mode switch is stepped to this function, and when the + side of the switch 24 is depressed, the SpAudio turns on. In a similar manner, when the - side of the switch 24 is depressed the SpAudio turns off.

A Summer Timer icon 37 illuminates when the mode switch 23 is stepped to this function, and when the + side of the switch 24 is depressed, this function is turned on; in a similar manner, when the − side of switch 24 is depressed this function is turned off. The Summer Timer function is useful in a warm climate. For example, in a place like Arizona in the summer time the ambient temperature may be quite high. Also, a feature of the spa 16 is to continuously circulate the water by a heater to maintain a set temperature. In a warm climate, when using the water circulate feature, the water temperature may rise above a desired setting. Accordingly, by turning on the Summer Timer function, the water is not circulated continuously in order to help maintain the pre-set desired temperature.

Another function indicated by the display 22 is a Lock icon 38. The Lock function can do two things. First, the entire spa system can be locked so that no one can make changes to the settings − unless they have the remote control. Secondly, the temperature setting can be locked to a pre-selected setting while the other functions are accessible.

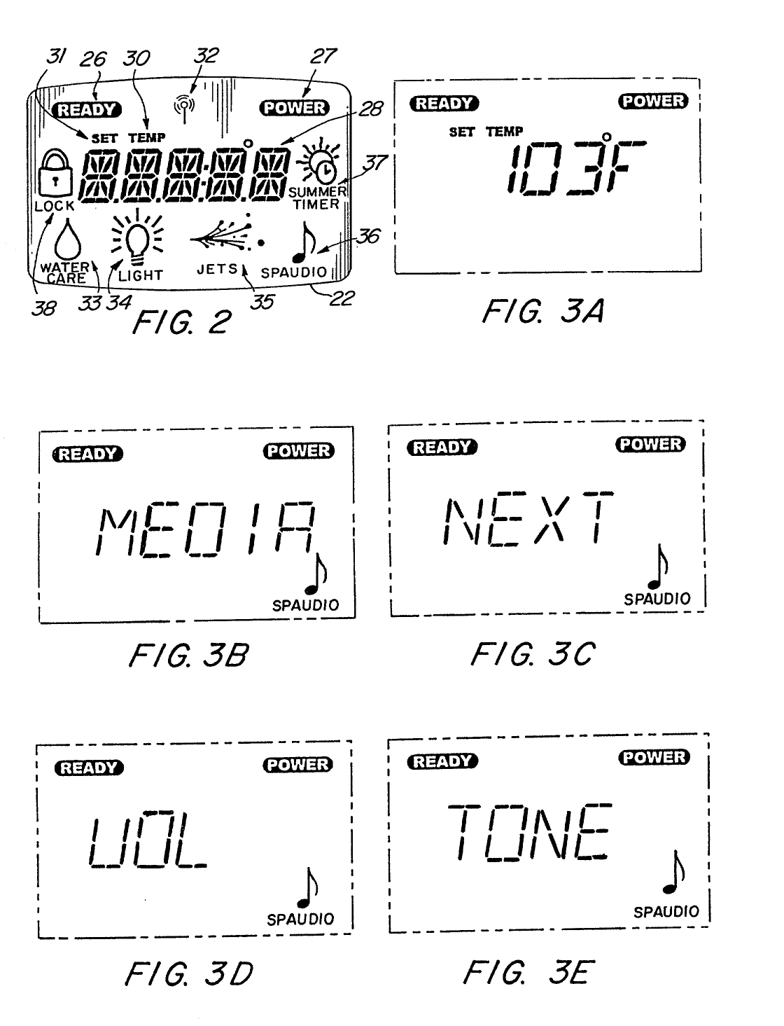

Referring now to FIGS. 3A through 3F, a variety of displays that may be shown by the display 22 of the remote control 10 are depicted. FIG. 3A shows a set temperature display, which is explained in greater detail in the above-cited co-pending patent application Ser. No. 09/______,______. Note that the Ready and Power icons 26 and 27, respectively, are illuminated, as well as the Set and Temp icons, 31 and 32, respectively; and, the temperature setting of 103° F. is shown. FIG. 3B shows the display when the remote control 10 is set in the Media mode. Note that the word MEDIA appears across the display array 28. FIG. 3C shows the SpAudio function is in the NEXT mode, which means that each depression of the switch 24 will step to the next radio station or track on a CD for example, of the stereo system 12. FIG. 3D shows the display when the SpAudio function is in the Volume setting mode. Each depression of the switch 24 will increase or decrease the volume setting of the stereo system 12. FIG. 3E shows the display array 28 when the SpAudio function is in the Tone setting mode. Each depression of the switch 24 will change the tone of the stereo system 12, wherein depressing the plus side of the switch 24 increases treble tone while depressing the minus side decreases treble or increases bass. FIG. 3F shows the display array 28 when the SpAudio function is in the Equalizer mode. Each depression of the switch 24 will select a different equalization curve, wherein each curve is preset for a different type of music. For example, curve one could be pre-set for classical music, curve two could be pre-set for jazz, curve 3 could be pre-set for rock and roll, curve 4 could be pre-set for soft music and curve 5 could be pre-set for easy listening.

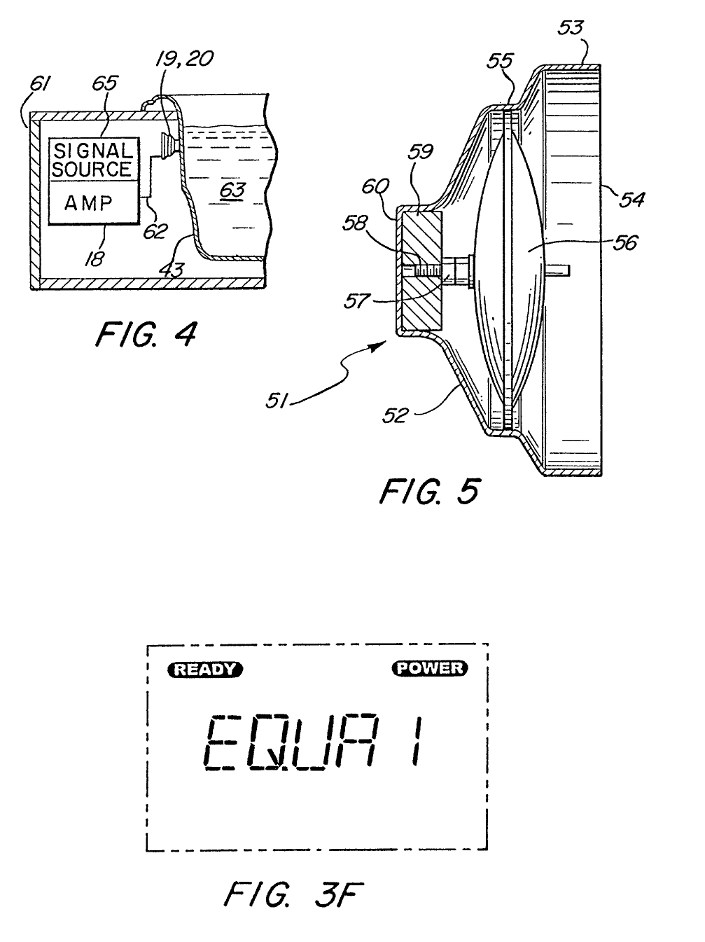

FIG. 4 illustrates a spa audio system according to an embodiment of the present invention. According to this embodiment, audio transducer devices 19, 20 are bonded to a spa shell 43. The transducer devices 19, 20 couple the sound vibration energy so that sound can be heard when using the spa. Two transducer devices 19, 20 are preferably provided for stereo effect but one device or more than two devices may also be used. The transducer devices 31 are driven by the amplifier 18.

The spa shell 43 is rigid enough to support the weight of water and bathers but is sufficiently compliant to reproduce the full range of audio frequencies. A typical spa shell 43 is formed of thermoset plastic or thermoplastic and has a thickness of 100″-300″. Of course, other materials and dimensions providing the functional prerequisites for water/bather support and audio transmission may be employed.

Rigid engagement of each transducer device 19, 20 to the spa shell 43 is required. The installation method preferably prevents spa insulation material from contaminating the transducer/shell coupling. This is achieved by constructing the transducer device 31 as a formed enclosure that surrounds a transducer element. A suitable audio transducer element is Model TST 329 as available from Clark Synthesis, Inc. , 8122 S. Park Lane, Littleton, Colo. 80120.

An illustrative formed enclosure 51 is shown in FIG. 5. This enclosure 51 includes a thermoformed molded plastic housing 52, which may be fabricated, for example, from ⅛″ ABS plastic. The housing 52 includes an outer cylindrical shell portion 53, which provides a circular rim or edge 54.

Adjacent the rim 54 of the enclosure 51, a somewhat smaller concentric cylindrical portion 55 is provided, which is of a diameter selected to support the outer rim 54 of the transducer element 56. A nut 57 is threaded onto a threaded projection of the transducer 56 and receives a threaded end of a stud 58. The stud 58 threads into a plastic cylinder 59 formed in a closed end 60 of the housing 52, thereby attaching and further supporting the transducer 56 within the housing. Attachment of the closed end 60 to the spa shell 43 is preferably provided by gluing the end 60 to the shell 43 using e.g., ABS glue or other typical adhesives such as fiberglass or permalite. Structural foam might also be used.

Additionally, support to the rim 54 of the housing 52 may be provided, for example, via a brace attached to the spa frame structure in order to relieve any shear stress created by hanging the housing/transducer assembly off the side of the spa shell 43. A hatch or door in the spa skirt 61 may also be provided to access the enclosures and equipment.

The output signal of the amplifier 18 may be coupled to the transducers via conventional speaker wire 62. In such case, the amplifier 18 and a signal source 65 supplying inputs thereto, such as a tuner or CD player, may be located in a compartment within the spa skirt 61 or elsewhere, such as in the structure 14. Alternatively, as shown in FIG. 1, the remote transceiver 13 (e.g., RF) may be used to enable use of the homeowner's home audio system 12 as the music signal source. Such remote transmitting devices are commercially available, for example, the 900 MHz or 2.4 GHz wireless receiver/transmitters provided by X-10 USA, Closter, N.J. 07624.

In operation, the audio can be heard under water 63 as well as above the water. Listeners outside the spa can also hear the audio signal, but the experience is muted compared to that of the tub occupant.

As may be appreciated, the disclosed embodiment permits the audio transducer devices to be enclosed within the spa, providing improved aesthetics by eliminating exposed speaker locations. Enclosing the transducer devices within the spa also protects them from water and reduces the risk of water exposure to electrical signals.

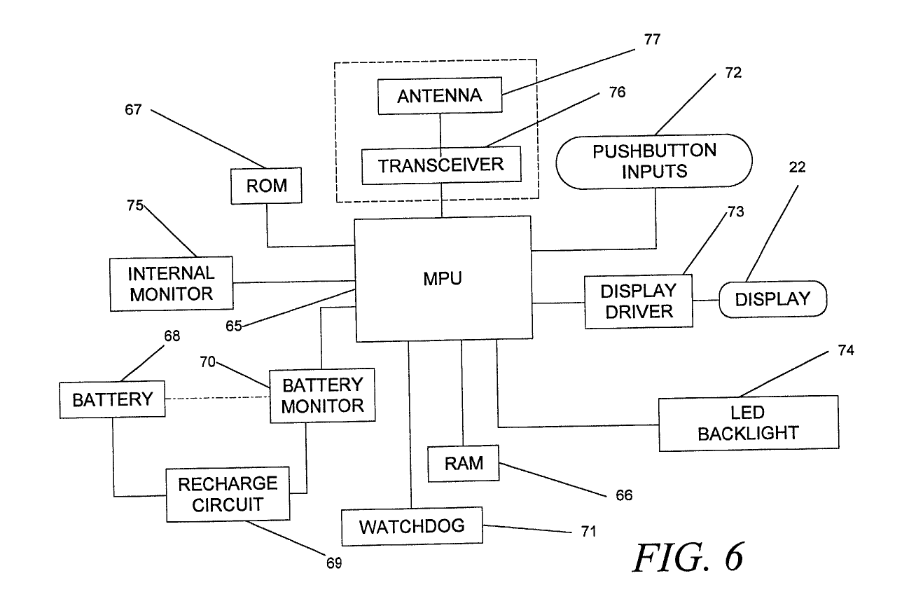

Referring now to FIG. 6, a block diagram of the electronic structure of the remote control is shown. The center of the remote control 10 is a Microprocessor Unit (“MPU”) 65. The MPU 65 has coupled thereto a RAM 66 and a ROM 67, which are conventional peripherals to a microprocessor and will not be described further herein. Also, the MPU 65 is powered by a battery 68, which in a specific embodiment includes three AAA batteries. A battery recharge circuit 69 and a battery monitor 70 are coupled between the battery 68 and the MPU 65, which are also well known in the art and will not be amplified further herein. A watchdog circuit 71 is also coupled to the MPU 65 to make sure the commands are being executed properly.

Pushbutton inputs 72 are coupled to input terminals of the MPU 65 to receive signals from the mode button 23 or the +/− switch 24. Display Driver 73 are coupled to outputs of the MPU 65 in a conventional manner, which in turn drive the display 22 described hereinabove. The display 22 also includes a back light 74 made up of Light Emitting Diodes (“LED”). An Internal Monitor circuit 75 is disposed for detecting any non-conforming operation of the MPU 65. RF signals are transmitted from the remote control 10 or received from the transceiver 13 by means of another transceiver 76 and an antenna 77.

From the above description, those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

What is claimed is:

1. A spa audio system comprising:
a spa shell; and
transducer means attached to said spa shell for coupling sound vibration energy to said spa shell.

2. The spa audio system of claim 1 further including an amplifier located adjacent to said spa shell for supplying an audio signal to said transducer means.

3. The spa audio system of claim 2 further including radio frequency transmission means for transmitting a user home audio signal to a radio frequency receiver means located adjacent to said spa shell.

4. The spa audio system of claim 1 wherein said transducer means includes a transducer element mounted within an enclosure.

5. The spa audio system of claim 4 wherein said enclosure has a rim attached to the spa shell.

6. The spa audio system of claim 5 wherein said rim is attached to the spa shell by an adhesive.

7. The spa audio system of claim 5 wherein said enclosure has a first cylindrical portion defining said rim at one end thereof and a second cylindrical portion wherein a circular rim of said transducer element is mounted.

8. The spa audio system of claim 7 further including means in a closed end of said enclosure for further supporting said transducer element.

9. In a spa having a flexible shell for holding water, an audio system for said spa comprising:
a) a first transceiver coupled to a source of audio signals and being disposed at a location other than said spa;
b) a second transceiver coupled to an input of an amplifier and having an output thereof; and
c) an audio transducer attached to an outer portion of said spa shell and being coupled to said output of said amplifier.

10. The spa audio system according to claim 9 wherein said source of audio signals is a home stereo system.

11. The spa audio system according to claim 10 wherein said second transceiver is responsive to RF signals from a remote control and is coupled to a main control of said spa.

12. The spa audio system according to claim 11 wherein said main control relays control signals to said first transceiver via said second transceiver for making selections of said home stereo system.

13. The spa audio system according to claim 12 wherein said selection of said home stereo system is volume control.

14. The spa audio system according to claim 12 wherein said selection of said home stereo system is media selection.

15. The spa according to claim 12 wherein said selection of said home stereo system is tone control.

16. The spa according to claim 12 wherein said selection of said home stereo system is sound equalization control.

17. In a spa having a flexible shell for holding water and a main control for controlling functions of said spa, an audio system for said spa comprising:
a) a first transceiver coupled to a home stereo system;
b) a second transceiver coupled to said main control;
c) an amplifier having an input coupled to said main control and having an output;
d) an audio transducer attached to an outer portion of said shell for coupling sound vibration energy to said spa shell and being coupled to said output of said amplifier.

18. The spa audio system according to claim 17 wherein said main control is responsive to RF signals from a remote control and received by said second transceiver.

19. The spa audio system according to claim 18 wherein said main control relays control signals to said first transceiver via said second transceiver for making selections of said home stereo system.

20. The spa audio system according to claim 19 wherein said selection of said home stereo system is volume control.

21. The spa audio system according to claim 20 wherein said selection of said home stereo system is media selection.

22. The spa audio system according to claim 21 wherein said selection of said home stereo system is tone control.

23. The spa audio system according to claim 22 wherein said selection of said home stereo system is sound equalization control.
